(19) United States
(12) Patent Application Publication
(10) Pub. No.: US 2011/0041931 A1
(43) Pub. Date: Feb. 24, 2011

(54) Diesel Fuel Pump Module with Fuel Wax By-Pass

(75) Inventors: William L. Villaire, Clarkston, MI (US); Robert Halsall, Washington, MI (US); Mitchell E. Hart, Grand Blanc, MI (US)

Correspondence Address: Keefe and Associates, 24405 Gratiot Avenue, Eastpointe, MI, 48021, US

(73) Assignee: GMGLOBAL TECHNOLOGY OPERATIONS, INC., DETROIT, MI (US)

(21) Appl. No.: 12/545,382

(22) Filed: Aug. 21, 2009

(51) Int. Cl. F16K 31/06; B65D 88/54

(52) U.S. Cl. 137/544; 137/565.35

(57) ABSTRACT

A by-pass fuel system configured so that in the event diesel fuel has waxed and/or ice crystals have formed such that the fuel cannot pass easily through the fuel pump fuel strainer, the diesel fuel is selectively able to pass through an auxiliary fuel port via a by-pass valve, thereby ensuring adequate fuel flow to the diesel engine. Return fuel heated by the engine is preferably directed directly onto the fuel pump fuel strainer to help dissolve the waxing and crystallization. An auxiliary coarse fuel strainer optionally provides coarse fuel straining of the by-passed fuel.

### TECHNICAL FIELD

The present invention relates to fuel pump modules which are interfaced with fuel tanks for motor vehicles, and more particularly to a by-pass fuel system, wherein when waxed diesel fuel blocks the fuel pump fuel strainer, waxed fuel is able to by-pass the fuel pump fuel strainer via an auxiliary fuel port and by-pass valve.

### BACKGROUND OF THE INVENTION

Motor vehicle fuel tanks provide not only a reservoir for fuel but also must have accommodation for adding fuel, delivering fuel (i.e., to the engine) and monitoring the amount of the fuel therein. It has become a common practice to combine the fuel delivery and monitoring functions via a fuel pump module which is removably interfaced with an opening of the fuel tank outershell.

FIG. 1 depicts an example of a motor vehicle fuel tank 10 having, by way of example, a saddle shape featuring two fuel sumps 10a, 10b. The fuel tank outershell 12 is provided with first and second openings 12a, 12b, each opening being disposed over a respective fuel sump 10a, 10b. At the first sump 10a, and interfaced sealingly with the first opening 12a, is a fuel pump module 14, and at the second sump 10b and interfaced sealingly with the second opening 12b is a secondary fuel transfer source 16 which is fluidically connected to the fuel pump module 14 via a transfer line 18.

The fuel pump module 14 is part of a by-pass fuel system. With respect to by-pass fuel systems, there are feed and by-pass fuel lines which loop the fuel back to the fuel pump module or loop the fuel within the fuel pump module. The term “by-pass fuel system” refers to both “return fuel systems” and “mechanical returnless fuel systems”.

FIG. 2 depicts a schematic representation of the functional aspects of a fuel pump module 20 utilized in the prior art, as for example in the manner of fuel pump module 14 in FIG. 1 with respect to a fuel tank of a return fuel system for diesel fuel delivery to a diesel engine. A module reservoir 22 is defined by a plastic module sidewall 20a. A fuel pump 24 draws reservoir fuel F_{R} through a hollow fuel pump fuel strainer 26 in the module reservoir, and the strained fuel F_{S} is then pumped by the fuel pump 24, and the strained pumped fuel F_{P} is then delivered to the diesel engine 40 via an inline fuel filter 28 and feed fuel line 30.

The by-pass fuel system continuously pumps fuel, and any amount not utilized by the engine is returned, via a return fuel line 34, as a by-pass strained fuel F_{B} to the fuel pump module 20, wherein a pressure regulator (not shown) may be located between the fuel pump 24 and the diesel engine 40. The by-pass strained fuel F_{B} is discharged by a jet pump 36 via a standpipe 38 into the module reservoir 22. In this regard, because the by-pass strained fuel F_{B} mixes with the reservoir fuel F_{R} already in the module reservoir, it becomes no longer separate as a uniquely identifiable entity and becomes merely a mixed aspect of the reservoir fuel F_{R} component, wherein all of the reservoir fuel must be strained before entry to the fuel pump.

While this arrangement of the prior art works well, there could be a situation in which the diesel fuel waxes in the sense it “clouds”, becoming too viscous to pass through the fuel pump fuel strainer, whereupon fuel passage through the fuel pump fuel strainer could become strangled. Such a situation might occur, for example, if very cold conditions are present in which waxing of the diesel fuel and/or ice crystallization occurs causing fuel blockage at the fuel pump fuel strainer, whereupon the diesel engine may become starved of fuel.

Accordingly, it would be desirable for by-pass fuel systems if somehow when waxed fuel blocks the fuel pump fuel strainer, nevertheless waxed fuel will be delivered at the rate requested by the engine via the fuel pump.

### SUMMARY OF THE INVENTION

The present invention is a by-pass fuel system configured so that in the event diesel fuel has waxed and/or ice crystals have formed such that the fuel is blocked at the fuel pump fuel strainer, the diesel fuel is selectively able to pass through an auxiliary fuel port to the fuel pump, thereby maintaining compliance with fuel demand of the diesel engine.

The fuel wax by-pass system according to the present invention features and an auxiliary fuel port, a normally closed by-pass valve (i.e., a pressure relief valve), and, optionally, an auxiliary coarse fuel strainer, wherein the fuel wax by-pass system is fluidically connected with the fuel pump. The normally closed by-pass valve prevents fuel from passing through the auxiliary fuel port to the fuel pump unless at least a predetermined fuel pressure differential exists between the (lower) fuel pressure internal to the fuel pump fuel strainer and the (higher) fuel pressure adjacently external to the fuel pump fuel strainer, wherein then the by-pass valve switches to an open state such that fuel is allowed to flow through the auxiliary fuel port to the fuel pump.

In operation, diesel fuel will normally flow freely through the fuel pump fuel strainer such that the fuel pressure differential as between the fuel pressure external and internal to the fuel pump fuel strainer is less than the predetermined fuel pressure differential in response to fuel pumping by the fuel pump, wherein the by-pass valve is in its normally closed state and no fuel passes through the auxiliary fuel port. In the event the fuel becomes blocked at the fuel pump fuel strainer, as for example in a situation in which the fuel has waxed and/or ice crystals have formed, as for example in a cold fuel tank environment, such that the fuel does not flow freely through the fuel pump fuel strainer in response to fuel pumping by the fuel pump, then the fuel pressure differential will increase. Should the fuel pressure differential reach (or exceed) the predetermined fuel pressure differential, the normally closed by-pass valve, which senses the fuel pressure differential, will thereupon assume an open state, whereupon the waxed fuel and/or crystals can now pass through the auxiliary fuel port and the auxiliary coarse fuel strainer, if present, to the fuel pump, thereby providing the fuel rate required by the engine. As long as the differential fuel pressure remains greater than the predetermined fuel pressure differential, the by-pass valve will remain open and allow passage of fuel through the auxiliary fuel port to the fuel pump. However, when the waxing and/or crystallization has lessened (i.e., dissolved) such that the fuel pressure differential has lowered so as to pass below the predetermined fuel pressure differential, then the by-pass valve will assume its normally closed state so as to prevent fuel from flowing through the auxiliary fuel port.

It is preferred for the auxiliary fuel port to be disposed at an elevated position in the module reservoir, being elevated with respect to the fuel pump fuel strainer, whereby contaminants will be generally disposed beneath, and away from, the auxiliary fuel port. It is further preferred for the return strained fuel to be flowingly discharged as a stream toward (i.e., onto) the fuel pump fuel strainer, whereby the return fuel warmed by heat of the diesel engine will tend to assist dissolving (i.e., melting) of any waxed fuel and/or ice crystals surrounding the fuel pump fuel strainer.

Accordingly, it is an object of the present invention to provide a by-pass fuel system configured so that in the event diesel fuel has waxed and/or ice crystals have formed such that the fuel is blocked from passing through the fuel pump fuel strainer, the diesel fuel will be selectively able to pass through an auxiliary fuel port so as to thereby maintain compliance with fuel demand from the diesel engine.

This and additional objects, features and advantages of the present invention will become clearer from the following specification of a preferred embodiment.

### BRIEF DESCRIPTION OF THE DRAWINGS

FIG. 1 is a perspective view of a fuel tank, showing in particular a fuel pump module interfaced therewith.

FIG. 2 is a schematic representation of a prior art fuel pump module for a fuel tank of a by-pass fuel system.

FIG. 3 is a schematic representation of a fuel pump module for a fuel tank of a by-pass fuel system including a fuel wax by-pass system according to the present invention, wherein the fuel wax by-pass system includes an auxiliary coarse fuel strainer.

FIG. 3A is a top plan view seen along line 3A-3A of FIG. 3.

FIG. 4 is a schematic representation of a fuel pump module for a fuel tank of a by-pass fuel system including a fuel wax by-pass system similar to FIG. 3, wherein now the fuel wax by-pass system does not include an auxiliary coarse fuel strainer.

FIG. 4A is a top plan view seen along line 4A-4A of FIG. 4.

FIG. 5 is a schematic representation of a fuel pump module for a fuel tank of a by-pass fuel system including an alternative example of fuel wax by-pass system according to the present invention.

FIG. 6 is a schematic representation of a fuel pump module for a fuel tank of a by-pass fuel system including the fuel wax by-pass system of FIG. 3, shown in operation by-passing fuel during a waxed fuel and/or ice crystallization event.

### DESCRIPTION OF THE PREFERRED EMBODIMENT

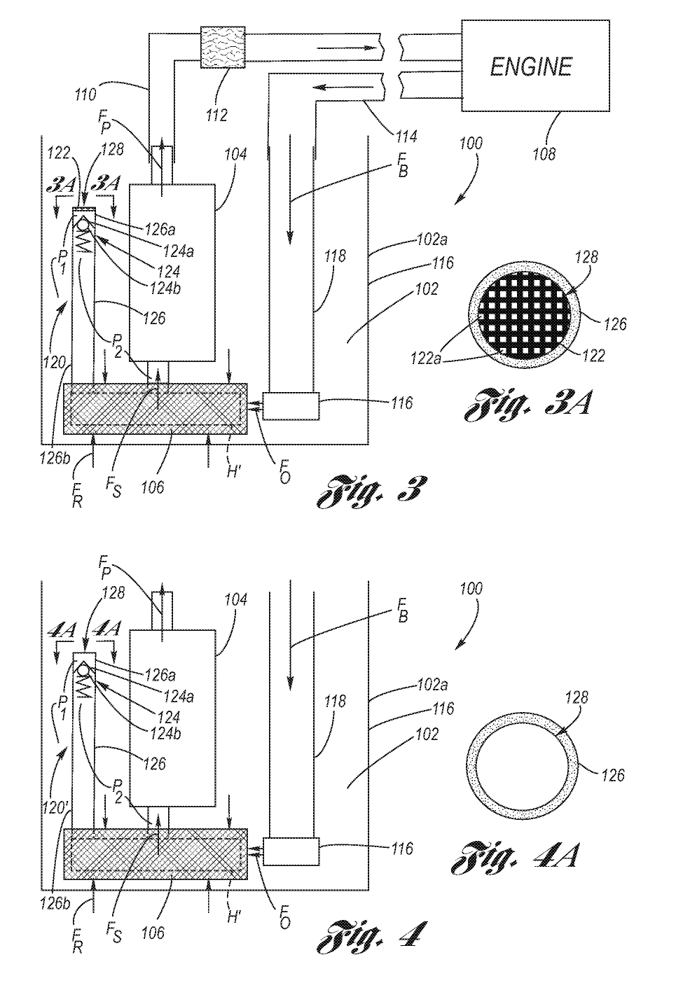

Referring now to the Drawing, FIGS. 3 through 6 depict various aspects of a fuel pump module for a fuel tank of a by-pass fuel system including a fuel wax by-pass system according to the present invention.

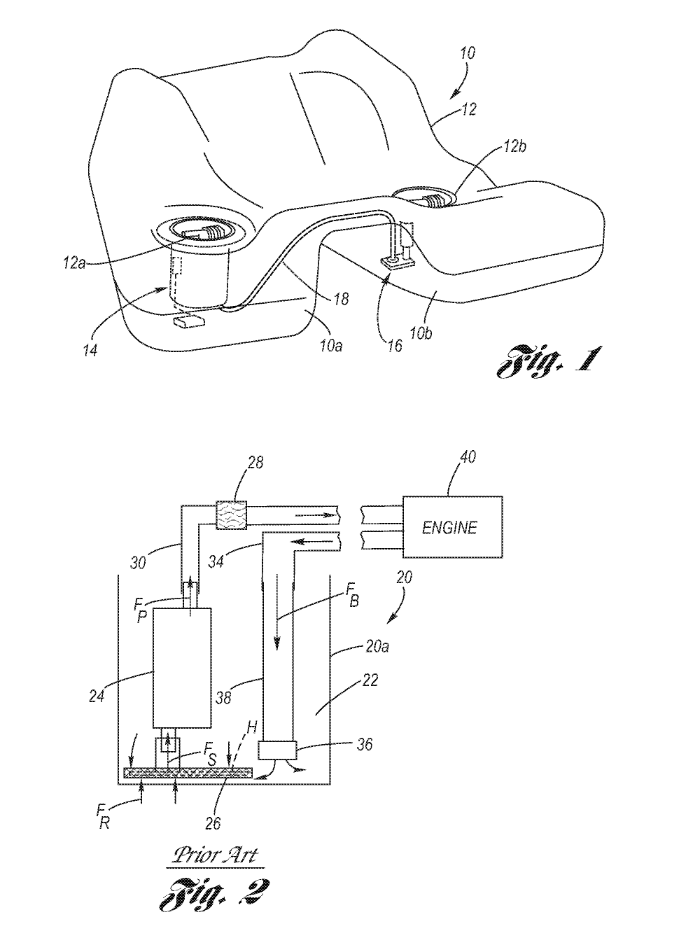

FIG. 3 depicts a schematic representation of the functional aspects of a fuel pump module 100, as for example in the manner of fuel pump module 14 in FIG. 1, with respect to a fuel tank of a return fuel system for diesel fuel delivery to a diesel engine.

A module reservoir 102 is defined by a plastic module sidewall 102a. A fuel pump 104 draws reservoir fuel F_{R} through a hollow fuel pump fuel strainer 106 in the module reservoir, and the strained fuel F_{S} is then pumped by the fuel pump 104 to the diesel engine 108, wherein the strained pumped fuel F_{P} is then delivered to the diesel engine via a feed fuel line 110 with an inline fuel filter 112.

The by-pass fuel system continuously pumps diesel fuel, and any amount not utilized by the engine is returned, via a return fuel line 114, as a by-pass strained fuel F_{B} to the fuel pump module 100, wherein a pressure regulator (not shown) may be located between the fuel pump 104 and the diesel engine 108. The by-pass strained fuel F_{B} is discharged as a fuel flow stream F_{O} flowing directly onto the fuel pump fuel strainer 106 via a jet pump 116 disposed at the end of a standpipe 118, and thereupon mixes with, and becomes part of, the reservoir fuel F_{R}. In this regard, because the output fuel flow stream F_{O} has been heated by heat from the diesel engine 108, this heat is, in turn, imparted to the reservoir fuel surrounding the fuel pump fuel strainer 104, whereby any waxed fuel and/or ice crystals are dissolved.

So that the fuel pump module 100 is able to operate well at temperatures in which the fuel has waxed and/or ice crystals have formed causing blockage of passage of the reservoir fuel F_{R} through the fuel pump fuel strainer 106 to the fuel pump 104, a fuel wax by-pass system 120, 120′, 102″ according to the present invention is provided.

Referring now to FIGS. 3 and 3A, the fuel wax by-pass system 120 includes an auxiliary fuel port 128 and a normally closed by-pass valve 124, wherein an auxiliary coarse fuel strainer 122 is also preferably included. The fuel wax by-pass system 120 is fluidically connected to the fuel pump 104, preferably via the hollow H′ of the fuel pump fuel strainer 106.

The auxiliary coarse fuel strainer 122, which although optional, is preferred to be included (by way of comparison, the auxiliary coarse fuel strainer is not included at FIGS. 4 and 4A). The auxiliary coarse fuel strainer 122 is disposed preferably at the auxiliary fuel port 128 and has an opening mesh size larger than that of the opening mesh size of the fuel pump fuel strainer such that waxed fuel and/or ice crystals can pass through the openings 122a of the auxiliary coarse fuel strainer, yet large contaminants cannot. The auxiliary coarse fuel strainer may include an integral particle restrictor or separate straining/filter component. For non-limiting example, the opening mesh size of the auxiliary coarse fuel strainer 122 may have openings 122a with a cross-section range of from about 1 mm and larger. By way of comparison and non-limiting example of the opening mesh size of the fuel pump fuel strainer 106 may range from about 0.1 mm to about 0.5 mm. As the cross-section of the openings 122a of the auxiliary fuel strainer 122 are larger, then the auxiliary fuel port 128 is less obstructed. Indeed, as shown at FIGS. 4 and 4A the auxiliary coarse fuel strainer may be omitted, the auxiliary fuel port 128 being unobstructed.

The location of the auxiliary fuel port 128 (and preferably the location of the auxiliary coarse fuel strainer 122, if present) is preferably elevated in relation to the module reservoir 102. For non-limiting example, the auxiliary fuel port 128 may be disposed between about 20.0 mm and about 50.0 mm in height from the floor of the module reservoir 102. In this regard, because contaminants tend to form sediments at the bottom portion of the module reservoir 102, by placing the auxiliary fuel port 128 high in the module reservoir, yet below typical fuel level in the module reservoir so as to be disposed in the fuel, the likelihood of the sentimented particulates reaching the auxiliary fuel port is minimized.

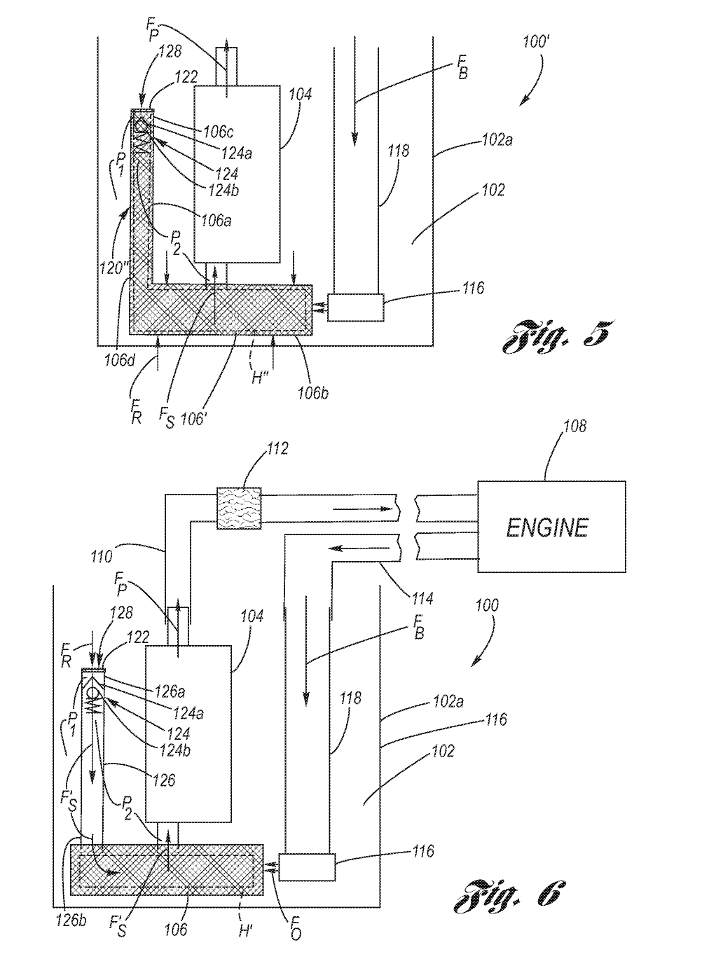

In order to provide an elevated disposition of the auxiliary fuel port 128, as shown at FIGS. 3 through 4A, the fuel wax by-pass system 120, 120′ includes a generally vertically oriented by-pass tube 126 which fluidically communicates at its upper, superior elevation, end 126a with the reservoir fuel F_{R} via the auxiliary fuel port 128 (and via the auxiliary fuel strainer 122 of FIGS. 3 and 3A), and fluidically communicates at its lower, inferior elevation, end 126b with the hollow H′ of the fuel pump fuel strainer 106. On the other hand, as shown at FIG. 5 (wherein the fuel pump module 100′ has like functioning and labeled parts as that of FIG. 3), the fuel wax by-pass system 120″ includes a fuel pump fuel strainer 106′ which is generally L-shaped, having a generally vertically oriented strainer hollow leg 106a and hollow main body 106b, wherein the strainer leg fluidically communicates at its upper, superior elevation, end 106c with the reservoir fuel F_{R} via the auxiliary fuel port 128 (and optionally via the auxiliary coarse fuel strainer 122), and its hollow H″ fluidically communicates at its lower, inferior elevation, end 106d with the hollow H″ of the main body 106d.

The normally closed by-pass valve 124 is, for example, a resiliently biased closed pressure relief valve, or other normally closed valve, in which the open and closed states are pressure determined, and wherein the by-pass valve is normally closed under normal operating fuel pressures. The by-pass valve 124 is disposed between the auxiliary fuel port 128 (and also the auxiliary coarse fuel strainer 122, if present) and the fuel pump 104, most preferably the hollow of the fuel pump fuel strainer 106, 106′, and senses the fuel pressure differential as between the fuel pressure P₁ of the reservoir fuel F_{R} at its external valve side 124a and the fuel pressure P₂ of the strained fuel F_{S} within the fuel pump fuel strainer at its inner valve side 124b, wherein if P₁ minus P₂ equals the differential pressure, ΔP.

The normally closed by-pass valve 124 prevents fuel from passing through the auxiliary fuel port 128 to the fuel pump 104 when in its closed state, but allows fuel to pass through the auxiliary fuel port to the fuel pump when in its open state. A predetermined fuel pressure differential ΔPP is determined, for example based upon empirical testing or other method, which is indicative of a fuel flow situation in which fuel is being blocked at the fuel pump fuel strainer 106, 106′ as for example due to waxing or icing. If the pressure differential ΔP sensed at the by-pass valve 124 between the (lower) fuel pressure P₂ internal to the fuel pump fuel strainer and the (higher) fuel pressure P₁ external to the fuel pump fuel strainer is such that ΔP<ΔPP, then the by-pass valve remains in its closed state; however, if ΔP>ΔPP, then the by-pass valve switches to its open state such that fuel is allowed to flow through the auxiliary fuel port to the fuel pump.

In operation, diesel fuel will normally flow freely through the fuel pump fuel strainer 106, 106′ such that the fuel pressure differential as between the fuel pressure external and internal to the fuel pump fuel strainer is less than the predetermined fuel pressure differential in response to fuel pumping by the fuel pump 104, wherein the by-pass valve 124 is in its normally closed state and no fuel passes through the auxiliary fuel port 128. In the event that the fuel has waxed and/or ice crystals have formed, as for example in a cold fuel tank environment, the fuel may be blocked at the fuel pump fuel strainer and not flow freely therethrough in response to fuel pumping by the fuel pump, whereupon the fuel pressure differential increases. Should the fuel pressure differential exceed the predetermined fuel pressure differential, the normally closed by-pass valve will switch to its open state, whereupon the waxed fuel and/or crystals can now pass through the auxiliary fuel port (and through the auxiliary coarse fuel strainer, if present) and into the fuel pump, thereby providing the fuel rate required by the engine. As long as the differential fuel pressure ΔP remains greater than the predetermined fuel pressure differential ΔPP, the by-pass valve will remain in its open state and allow passage of fuel through the auxiliary fuel port to the fuel pump. However, when the waxing and/or crystallization has lessened (i.e., the wax/ice has dissolved) such that the fuel pressure differential has lowered so as to pass below the predetermined fuel pressure differential (i.e., ΔP<ΔPP), then the by-pass valve will switch back to its normally closed state.

Thus, it is seen that the fuel wax by-pass system according to the present invention includes unique and advantageous features. The fuel pump fuel strainer, which for diesel fuel is generally a weave, will clog when the diesel fuel temperature drops below its “cloud” point. However, in such circumstance the by-pass valve will open and the waxed fuel can pass through the auxiliary fuel port to the fuel pump. The auxiliary fuel port is disposed relatively high in the module reservoir, spaced away from settled particulates. The mesh size of the openings of the auxiliary coarse fuel strainer (if provided) are larger than that of the fuel pump fuel strainer, but yet will strain large particulates from passing to the fuel pump. Further, the module reservoir jet pump discharge is directed directly onto the fuel pump fuel strainer, which will speed elimination of waxed fuel and/or ice crystals around the fuel pump fuel strainer by raising the fuel temperature, in that the discharge is in the form of warmed engine return fuel.

To those skilled in the art to which this invention appertains, the above described preferred embodiment may be subject to change or modification. Such change or modification can be carried out without departing from the scope of the invention, which is intended to be limited only by the scope of the appended claims.

1. A fuel pump module for a by-pass fuel system, comprising:
a module reservoir;
a fuel pump disposed in said module reservoir;
a fuel pump fuel strainer connected to said fuel pump; and
a fuel wax by-pass system fluidically communicating with said fuel pump, said fuel wax by-pass system comprising:
an auxiliary fuel port disposed in said module reservoir; and
a by-pass valve disposed between said auxiliary fuel port and said fuel pump, said by-pass valve being operable between an open state and a closed state responsive to fuel pressure differential;
wherein said by-pass valve is in a normally closed state such that fuel is prevented from flowing through said auxiliary fuel port to said fuel pump such that as fuel is flowingly pumped in response to pumping by said fuel pump the fuel is strained by said fuel pump fuel strainer prior to reaching said fuel pump; however, if the fuel is blocked at said fuel pump fuel strainer such that at least substantially a predetermined fuel pressure differential exists between fuel internal to said fuel pump fuel strainer and fuel external to said fuel pump fuel strainer, then said by-pass valve switches to an open state such that fuel is allowed to flow through said auxiliary fuel port to said fuel pump.

2. The fuel pump module of claim 1, further comprising a return fuel discharge; wherein fuel pumped by said fuel pump is delivered to an engine and fuel unused by the engine is returned to said module reservoir by being directed toward said fuel pump fuel strainer by said return fuel discharge.

3. The fuel pump module of claim 1, further comprising an auxiliary coarse fuel strainer having an opening mesh size larger than an opening mesh size of said fuel pump fuel strainer, said auxiliary fuel port fluidically communicating with said fuel pump through said auxiliary coarse fuel strainer.

4. The fuel pump module of claim 3, wherein said auxiliary fuel port is disposed at a high elevation with respect to said module reservoir.

5. The fuel pump module of claim 3, further comprising a return fuel discharge; wherein fuel pumped by said fuel pump is delivered to an engine and fuel unused by the engine is returned to said module reservoir by being directed toward said fuel pump fuel strainer by said return fuel discharge.

6. The fuel pump module of claim 5, wherein said auxiliary fuel port is disposed at a high elevation with respect to said module reservoir.

7. The fuel pump module of claim 1, wherein:
said auxiliary fuel port is disposed at an upper end of a substantially vertically oriented by-pass tube, wherein a lower end of said by-pass tube is fluidically connected to a hollow of said fuel pump fuel strainer, and wherein said by-pass valve is disposed in said by-pass tube between said auxiliary fuel port and said fuel pump fuel strainer; and
said auxiliary fuel port is disposed at a high elevation with respect to said module reservoir.

8. The fuel pump module of claim 7, further comprising a return fuel discharge; wherein fuel pumped by said fuel pump is delivered to an engine and fuel unused by the engine is returned to said module reservoir by being directed toward said fuel pump fuel strainer by said return fuel discharge.

9. The fuel pump module of claim 7, further comprising an auxiliary coarse fuel strainer having an opening mesh size larger than an opening mesh size of said fuel pump fuel strainer, said auxiliary fuel port fluidically communicating with said fuel pump through said auxiliary coarse fuel strainer.

10. The fuel pump module of claim 9, further comprising a return fuel discharge; wherein fuel pumped by said fuel pump is delivered to an engine and fuel unused by the engine is returned to said module reservoir by being directed toward said fuel pump fuel strainer by said return fuel discharge.

11. The fuel pump module of claim 1, wherein:
said fuel pump fuel strainer has a generally L-shape comprising a generally vertically oriented hollow leg integrally joining a hollow main body, wherein said auxiliary fuel port is disposed at an upper end of said leg, wherein a lower end of said leg joins said main body, and wherein said by-pass valve is disposed in said leg between said auxiliary fuel port and said main body; and
said auxiliary fuel port is disposed at a high elevation with respect to said module reservoir.

12. The fuel pump module of claim 11, further comprising a return fuel discharge; wherein fuel pumped by said fuel pump is delivered to an engine and fuel unused by the engine is returned to said module reservoir by being directed toward said main body of said fuel pump fuel strainer by said return fuel discharge.

13. The fuel pump module of claim 11, further comprising an auxiliary coarse fuel strainer having an opening mesh size larger than an opening mesh size of said fuel pump fuel strainer, said auxiliary fuel port fluidically communicating with said fuel pump through said auxiliary coarse fuel strainer.

14. The fuel pump module of claim 13, further comprising a return fuel discharge; wherein fuel pumped by said fuel pump is delivered to an engine and fuel unused by the engine is returned to said module reservoir by being directed toward said main body of said fuel pump fuel strainer by said return fuel discharge.

15. A fuel pump module for a by-pass fuel system, comprising:
a module reservoir;
a fuel pump disposed in said module reservoir;
a fuel pump fuel strainer connected to said fuel pump; and
a fuel wax by-pass system fluidically communicating with said fuel pump, said fuel wax by-pass system comprising:
an auxiliary fuel port disposed in said module reservoir;
a by-pass valve disposed between said auxiliary fuel port and said fuel pump, said by-pass valve being operable between an open state and a closed state responsive to fuel pressure differential; and
an auxiliary coarse fuel strainer having an opening mesh size larger than an opening mesh size of said fuel pump fuel strainer, said auxiliary fuel port fluidically communicating with said fuel pump through said auxiliary coarse fuel strainer;
wherein said by-pass valve is in a normally closed state such that fuel is prevented from flowing through said auxiliary fuel port to said fuel pump such that as fuel is flowingly pumped in response to pumping by said fuel pump the fuel is strained by said fuel pump fuel strainer prior to reaching said fuel pump; however, if the fuel is blocked at said fuel pump fuel strainer such that at least substantially a predetermined fuel pressure differential exists between fuel internal to said fuel pump fuel strainer and fuel external to said fuel pump fuel strainer, then said by-pass valve switches to an open state such that fuel is allowed to flow through said auxiliary fuel port to said fuel pump.

16. The fuel pump module of claim 15, further comprising a return fuel discharge; wherein fuel pumped by said fuel pump is delivered to an engine and fuel unused by the engine is returned to said module reservoir by being directed toward said fuel pump fuel strainer by said return fuel discharge.

17. A method for providing diesel fuel delivery to a fuel pump in a situation in which a fuel pump fuel strainer upstream of the fuel pump is blocked, comprising the steps of:
providing an auxiliary fuel port; and
controlling fuel flow through the auxiliary fuel port to the fuel pump, wherein if a fuel pressure differential between the fuel exterior to the fuel pump fuel strainer and the fuel interior to the fuel pump fuel strainer is substantially above a predetermined fuel pressure differential then fuel flow is permitted through the auxiliary fuel port to the fuel pump, otherwise fuel flow through the auxiliary fuel port to the fuel pump is prevented.

18. The method of claim 17, wherein the blockage of the fuel pump fuel strainer is due to at least one of fuel waxing and ice crystal formation; said method further comprising:
directing return fuel from an engine toward the fuel pump fuel strainer to thereby dissolve the at least one of the fuel waxing and the ice crystallization.

19. The method of claim 17, further comprising:
coarse straining the fuel passing through the auxiliary fuel port;
wherein the coarse straining allows passage to the fuel pump of particles larger than those strained by the straining of the fuel pump fuel strainer.

20. The method of claim 19, wherein the blockage of the fuel pump fuel strainer is due to at least one of fuel waxing and ice crystal formation; said method further comprising:
directing return fuel from an engine toward the fuel pump fuel strainer to thereby dissolve the at least one of the fuel waxing and the ice crystallization.
